(19) United States
(12) Patent Application Publication
(10) Pub. No.: US 2017/0168653 A1
(43) Pub. Date: Jun. 15, 2017

(54) CONTEXT-DRIVEN, PROACTIVE ADAPTATION OF USER INTERFACES WITH RULES

(71) Applicant: SAP SE, Walldorf (DE)

(72) Inventors: Patrik Spiess, Karlsruhe (DE); Florian Probst, Darmstadt (DE); Sebastian Doeweling, Griesheim (DE)

(21) Appl. No.: 14/965,233

(22) Filed: Dec. 10, 2015

(51) Int. Cl. G06F 3/0481; G06F 17/21

(52) U.S. Cl. CPC G06F 3/0481; G06F 17/212

(57) ABSTRACT

A situation description is received from a context engine, the situation description describing a context of a user. The user is associated with a graphical user interface, and the graphical user interface is associated with a screen area. A user interface adaption rule is identified based on the received situation description. A logical layout is determined based on the identified user interface adaptation rule. A physical layout is determined based on the logical layout. Display of the graphical user interface on the screen area is initiated based on the determined physical layout.

### BACKGROUND

Software today, whether built for consumers or business users, often offers a rich set of functionality that can easily make users feel overwhelmed. User efficiency is likely to suffer as important information or functionality gets lost in the plethora of options. Traditionally this problem has been amended by manual customization, either conducted by information technology (IT) administrators or consultants, or, for simple customizations, by users themselves. The disadvantage of this approach is that it requires a significant amount of effort, in particular when different users require different customizations. Automatically adapting user interfaces based on user context or interaction histories have, so far, had little success.

### SUMMARY

The present disclosure relates to context-driven, proactive adaptation of user interface.

A situation description is received from a context engine, the situation description describing a context of a user. The user is associated with a graphical user interface, and the graphical user interface is associated with a screen area. A user interface adaption rule is identified based on the received situation description. A logical layout is determined based on the identified user interface adaptation rule. A physical layout is determined based on the logical layout. Display of the graphical user interface on the screen area is initiated based on the determined physical layout.

Some implementations can include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes the system to perform the actions. One or more computer programs can be configured to perform particular operations or actions by virtue of including instructions that, when executed by data processing apparatus, cause the apparatus to perform the actions.

For example, in one implementation, a computer-implemented method includes: receiving a situation description from a context engine, the situation description describing a context of a user, wherein the user is associated with a graphical user interface, and the graphical user interface is associated with a screen area; identifying a user interface adaption rule based on the received situation description; determining a logical layout based on the identified user interface adaptation rule; determining a physical layout based on the logical layout; and initiating display of the graphical user interface on the screen area based on the determined physical layout.

The foregoing and other implementations can each optionally include one or more of the following features, alone or in combination:

A first aspect, combinable with the general implementation, wherein the situation description is derived from sensor data or information from a third party system that provides context information of the user.

A second aspect, combinable with the general implementation, wherein the situation description is a graph of data objects.

A third aspect, combinable with the general implementation, comprising fetching adaptation rules and initial logical layout, and initiating a connection to the context engine.

A fourth aspect, combinable with the general implementation, wherein determining a logical layout based on the identified user interface adaptation rule comprises determining semantic layout information of at least one user interface app window based on the identified user interface adaptation rule.

A fifth aspect, combinable with the general implementation, wherein the semantic layout information includes at least one of a semantic area, a window priority, or a preferred window size for the at least one user interface app window.

A sixth aspect, combinable with the general implementation, wherein determining the physical layout based on the logical layout comprises determining a window size and a window position of the at least one user interface application window based on the semantic layout information in the logical layout and properties of the screen area.

The subject matter described in this specification can be implemented in particular implementations so as to realize one or more of the following advantages. The described subject matter automatically adapts a user interface based on a user's context information (e.g., a user's current situation) derived from sensor data or third party systems. The user interface tailors information displayed and functionalities offered to the user based on the user's context, presenting most relevant information and hiding or minimizing irrelevant information on the screen. This lowers the user's cognitive load and helps the user focus on the task, minimizing distraction and increasing efficiency. The described subject matter also simplifies screen layout calculations by separating logical layout and physical layout. The logical layout, which is device-independent, is reused across different devices (e.g., a desktop or a mobile phone). The physical layout is recalculated according to different devices' properties. The subject matter also allows for scenarios where multiple users are logged in at the same time, showing information based on their combined information needs and/or authorizations. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example hardware/software user interface adaptation system for context-driven, proactive user interface adaptation, according to an implementation.

FIG. 2 illustrates an example rule editor for specifying an adaptation rule, according to an implementation.

FIG. 3 illustrates an example situation description, according to an implementation.

FIG. 4 illustrates an example adaptive user interface with visualization of tiles, according to an implementation.

FIG. 5 is a flow chart of an example method for context-driven, proactive user interface adaptation, according to an implementation.

FIG. 6 illustrates a first example of an adaptive user interface, according to an implementation.

FIG. 7 illustrates a second example of an adaptive user interface, according to an implementation.

FIG. 8 illustrates a third example of an adaptive user interface, according to an implementation.

FIG. 9 illustrates a fourth example of an adaptive user interface, according to an implementation.

FIG. 10 is a block diagram of an exemplary computer used for implementing the described subject matter, according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

The present description relates to context-driven, proactive adaptation of user interface (UI).

For the purposes of this disclosure, an “adaptive user interface (AUI)” refers to a graphical user interface (GUI) that adapts a screen layout or content in a software application to needs or a context of a user. Existing approaches of GUIs that attempt some type of GUI adaptation functionality often lack or have a narrow understanding of context, mostly referring to properties of the device, display resolution, interaction means (e.g., physical keyboard or touch keypad), pixel density etc. For example, GUI elements show different controls and use different interaction paradigms when displayed in a desktop browser window, on a tablet device, or on a smart phone. Some existing approaches define context as the state and/or configuration of the user interface itself. This context represents a record of the actions of a user on the user interface. Using this definition of context, the AUI scenarios turn out to be simplistic, such as opening the right tool to display a file based on the file extension or opening different context menus based on over which area of an application the user has clicked with the right mouse button. Some other existing approaches defines context as the experience or skill level of the user, providing simple or advanced versions of a user interface or more levels in between.

The described approach defines context in a much broader sense. The described approach, in addition to adapting to the context defined in the existing approaches, provides automatic and sophisticated adaptation based on a user's situation. For example, the described approach takes into account the user's work situation, such as the user's geospatial location within a company's premises, whether there is an exception in a production line the user is working on, whether a change in the production line is about to happen, etc. Integrated with a back-end system that can derive the user's situation information from sensors and third party systems, the described approach can display the most important and relevant information to the user while suppressing irrelevant information based on the user's situation. For example, when sensors on the product line detect that a new batch of products will start soon, the AUI may automatically pop out a window to a worker on the product line showing differences in assembly instructions between the old batch and the new batch (i.e., important). It is important because otherwise the worker may use the same assembly instructions for the new batch and assemble the product incorrectly. As another example, the sensors or information technology (IT) systems may detect that the user is reading an email from a certain sender or is currently in a phone conversation with a customer. The AUI can automatically display the email sender information or the customer information to the user (i.e., relevant). By pushing high-level events of the user's physical situation (captured by sensors or read from third party IT systems) to the application that runs the AUI, the described approach applies more meaningful and effective adaptations to the user interface, based on rich, domain-specific context information.

For the purposes of this disclosure, “sensor” is in a broad sense, ranges from physical sensors (e.g., reporting humidity, electrical current, room occupation, tracked locations of people or assets) to UI sensors (e.g., recording the user's interactions with applications on an operation system level) to conventional IT data sources (like databases, touched business objects) and the like. Further, the UI adaptation is not pre-defined, but rule-based (e.g., “if machine 4711 breaks down, bring a technician finder app to the front of the screen”). Based on the usage scenario, an administrator or a user can specify how the UI should be adapted in a given situation.

The described approach adapts the UI based on situation descriptions that featuring machine-readable semantics. These situation descriptions can either be (1) automatically derived from sensor inputs (e.g., “the user is located in his colleagues office and uses a customer relationship management (CRM) smart phone app to look at customer A while his colleague uses a desktop CRM application to look at A's order history”) or (2) manually declared by a user (e.g., “there is a tool failure on work station 3 of production line 5”). The semantic situation descriptions can be implemented by a graph of data objects or other data structures.

The described approach also adapts the GUI using a two-step approach. A logical layout is first determined and then a physical layout (i.e., the actual screen layout) is calculated. The logical layout can be device independent while the physical layout can be device dependent, e.g. dependent on a screen size of a desktop or a mobile phone. Contrary to existing approaches, which typically mix logical layout and actual screen layout, the described approach can reuse the logical layout across different devices. This simplifies the screen layout calculation because the physical layout is recalculated for the different devices but not the logical layout. In some cases, the AUI is displayed in a browser window. When changing a size of the browser window, the same logical layout can be reused and the physical layout is recalculated.

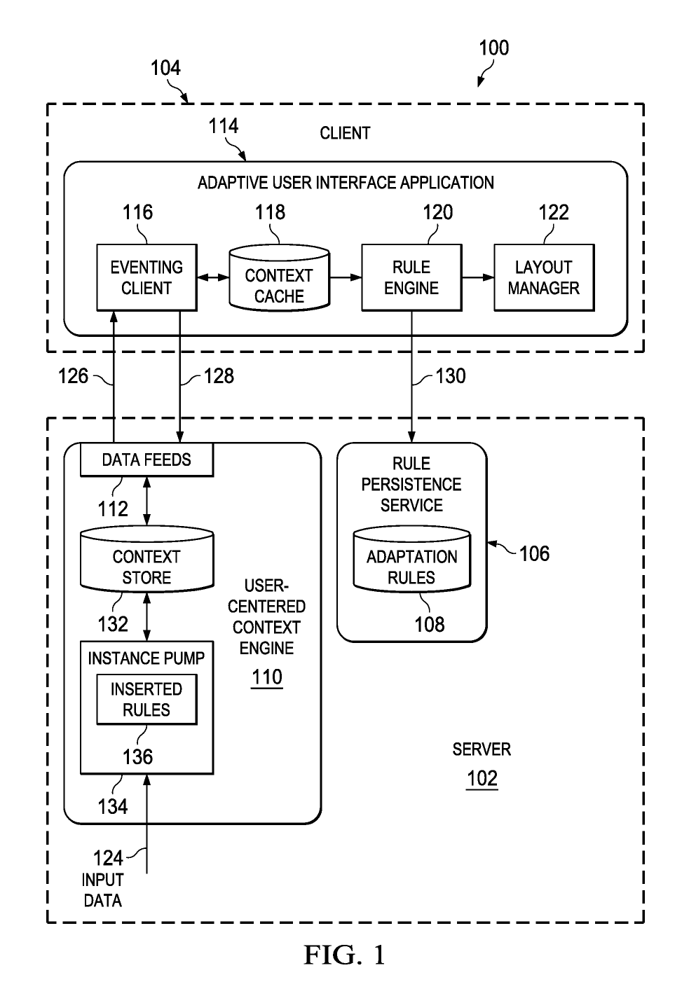

FIG. 1 is a block diagram illustrating an example hardware/software UI adaptation system 100 for context-driven, proactive UI adaptation, according to an implementation. The example system 100 normally includes a server 102 and a client 104. Typically, the server 102 includes a rule persistence service 106 including adaptation rules 108 and a user-centered context engine 110. The user-centered context engine 110 can include data feeds 112, a context store 132, and an instance pump 134 including inserted rules 136. The client 104 can include an AUI application 114. The AUI application 114 consists of an eventing client 116, a context cache 118, a rule engine 120, and a layout manger 122. In a typical implementation, the user-centered context engine 110 derives a situation description of the user's current context based on inputs 124 from sensors or third party systems, and sends the situation description to the AUI application 114. The UI adaptation application 114 retrieves the adaptation rules 108 from the rule persistence service 106 and adapts the GUI based on the received situation description and the adaptation rules. The AUI application 114 can be implemented as a browser application or a shell browser application, and the AUI can be displayed in the corresponding browser window. Each client can run one or more instances of the AUI application 114, but typically runs one. For example, in the product line scenario, each work station on the product line can run an instance of the AUI application 114 displayed using a computer-driven display (e.g., monitor, projector, mobile device, and the like). In some implementations, instead of being a separate application running on the client, the AUI application 114 can be a plug-in, built into an operation system, or other alternatives. In some implementations, as illustrated, the rule persistence service 106 and the user-centered context engine 110 can be implemented in a cloud-computing environment. Each cloud service can run one instance of the rule persistence service 106 and one instance of the user-centered context engine 110. The client 104 can be in a front-end computer system while the server 102 in a back-end computer system. As will be understood by those of ordinary skill in the art, the illustrated implementation is only one possible variation of a UI adaptation system 100 consistent with the teachings of this disclosure. Other variations are considered to be within the scope of this disclosure.

The user-centered context engine 110 can receive input data (inputs 124) from different data sources (e.g., physical sensors, user interface sensors, data sensors, sensors on the Internet of Things, and others) or third party systems and determines the user's current situation. The user's current situation can also be directly reported by external systems. A situation can be described by a graph of data objects or by a descriptive label. A semantic context engine can be used to generate the graph-like situation descriptions. The situation descriptions can be asynchronously pushed 126 from the user-centered context engine 110 to the AUI application 114. In some cases, the AUI application 114 can pull 128 the user-centered context engine 110 for the situation descriptions. In still other implementations, a combination of push and pull functionality can be used consistent with the disclosed implementations.

The user-centered context engine 110 can include data feeds 112. The data feeds can be parameterized. For example, in the product line scenario, there might be data feeds 112 that are relevant for the whole factory, for a specific production line, or for a specific work station on the product line. The AUI application 114 on a particular work station can subscribe to relevant data feeds 112 (e.g., the data feeds for that particular work station, the production line that particular work station belongs to, and the whole factory) but not to the data feeds delivering content for other work stations or production lines. When information from sensors or third party systems flowing into the user-centered context engine 110, the data feeds 112 are evaluated. If the evaluation detects new information that is relevant for the AUI application 114, the new situation description is sent to the AUI application 114. The data feeds 112 can be pushed 126 and/or pulled 128 for the new situation descriptions.

The UI adaptation system 100 can divide the functionality of a GUI into multiple UI apps, organized as small, independent web apps. In some implementations, the AUI can be implemented in SAP UI5 or other Hyper Text Markup Language (HTML) integrated using iframes or other structures. Each UI app can serve one particular feature of the AUI with respect to both presentation and interaction according to the user's context. Each UI app can be associated with a UI app window. Each UI app can be associated with metadata, describing if and how the UI app window should be displayed in the current user context. While not illustrated, the metadata can be stored in the UI app. The rule engine 120 can manipulate the metadata of the UI app based on the current user context and influence if and how the UI app window will be displayed in the AUI application 114, which leads to context-based UI adaptation. In a typical implementation, as will be discussed below, the layout manager 122 can resize the UI app windows based on the user's current context. The UI app can react autonomously on size changes of the UI app window by adapting the displayed content. It is the UI app's responsibility to display the content in a meaningful way at any app window size enforced by the layout manager 122, e.g. by showing a summary when the UI app window is minimized.

The rule persistence service 106 can include adaptation rules 108. The rule engine 120 in the AUI application 114 can pull 130 adaption rules from the rule persistence service 106 and execute the adaptation rules. The rule persistence service 106 can also push the adaptation rules into the rule engine 120. The adaptation rules can be associated with rule triggers. Rule triggers determine when an adaptation rule is executed. Examples of rule triggers can include, but are not limited to:
AUI application 114 startup,
situation description change,
trigger by UI apps that resides in the AUI application 114 or the user, and
external trigger.

The adaptation rules 108 can include rule functions. When the rule engine 120 executes the adaptation rules, the corresponding rule functions are executed. The rule functions can map the situation descriptions or the rule triggers to GUI adaption actions. The GUI adaptation actions can specify how the UI app windows should be laid out on the screen according to the rule triggers or situation descriptions. The GUI adaption actions can include setting a window state for each UI app window. The window state can specify the semantic layout needs of each UI app window. For example, the window state can include a preferred window size, a maximum window size, a window placement, a window priority, and others. The GUI adaptation actions can also include sending technical events to applications (e.g., UI apps within the AUI application 114 or external applications) and sending notifications to other users on mobile devices. As will be understood by those of ordinary skill in the art, other GUI adaptation actions consistent with this disclosure are also possible.

The window priority attribute in the window state can be used to determine which windows to hide in case the GUI screen area is too small to host all UI app windows. The window priority can include the following priority levels: exclusive, most important, important, default, less important, and least important. The exclusive priority indicates displaying the UI app window on the top and suppressing other windows. If there are one or more exclusive windows, the exclusive windows displace all other windows off the screen. This is a convenient way of bringing the attention to one UI app window and hiding everything else.

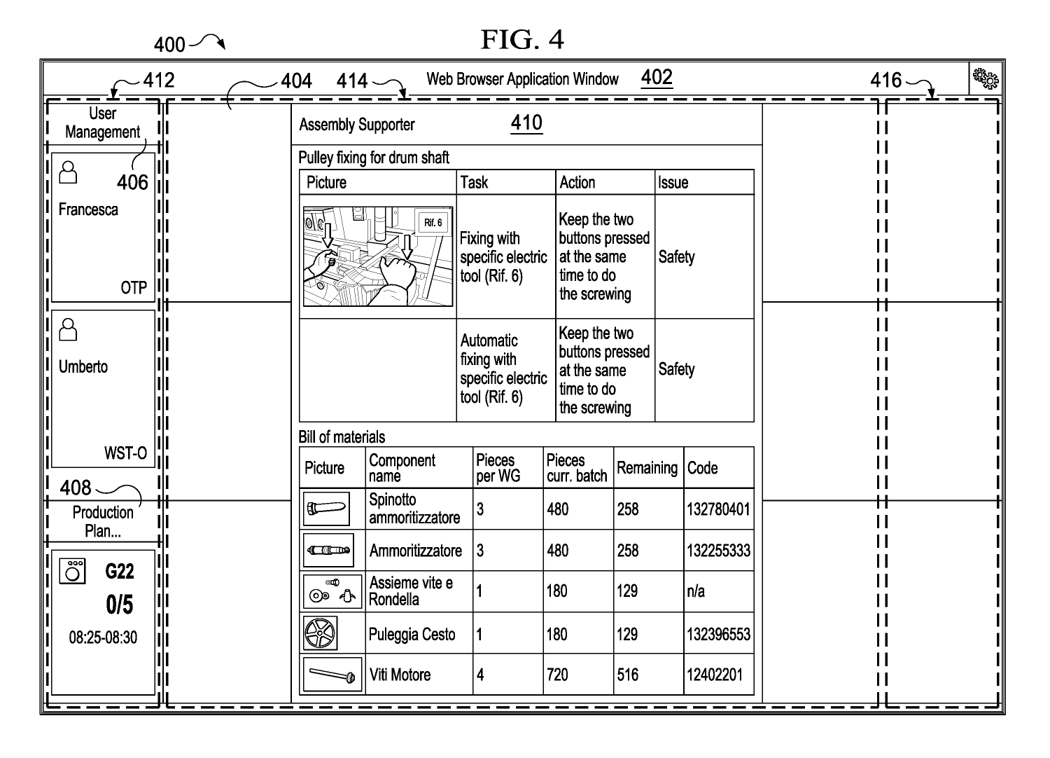

The window placement attribute in the window state defines the way the UI app window is displayed. Possible values of window placement are hidden, normal, minimized, and maximized. Hidden windows are not displayed. Normally placed windows are tried to be laid out at the window's preferred size. Minimized windows are placed in an icon state, e.g. at 1×1 tile size (tile will be discussed below with reference to FIG. 4). Lastly, maximized app windows are enlarged to whatever screen space left by non-maximized app windows with equal or higher priority, but not larger than the maximum window size specified in the window state. Should there be more than one maximized UI app, the layout manager 122 tries to divide the remaining screen space equally to the maximized UI app windows.

The rule function can include a number of parameters. The parameters can include a current situation describing the user's current context, a last situation describing the user's previous context, and window states specifying the semantic layout needs of the UI app windows. The current situation parameter can include the new situation description as stored in the context cache 118. The parameters of the current situation and the last situation can be a graph of data objects implemented in JavaScript objects or other data structures. For example, in the product line scenario, the current situation parameter can contain relevant information for the current workers' situation at the work station such as:
list of workers currently logged in,
the workers' experience and job role,
the current assembly task,
the current batch, and
information about exceptional situations, such as:
   machine breakdown,
   low material stock, and
   a worker is present at a wrong workstation.
      The window states can be directly manipulated by the adaptation rule based on the user's current context. In some implementations, the window states can contain a list of JavaScript objects or other data structures.

The adaptation rules can be created, edited, or deleted by a system administrator or a user using a browser-based rule editor or other editors. The rule editor can be used to specify the rule trigger and the rule function of a particular adaptation rule. Typically, adaption rules are authored in JavaScript, but could be in any other computing languages. The rule editor can allow persisting rule sets to a back-end computing service. A simple versioning feature can allow reverting to previous versions of adaptation rules in case of errors.

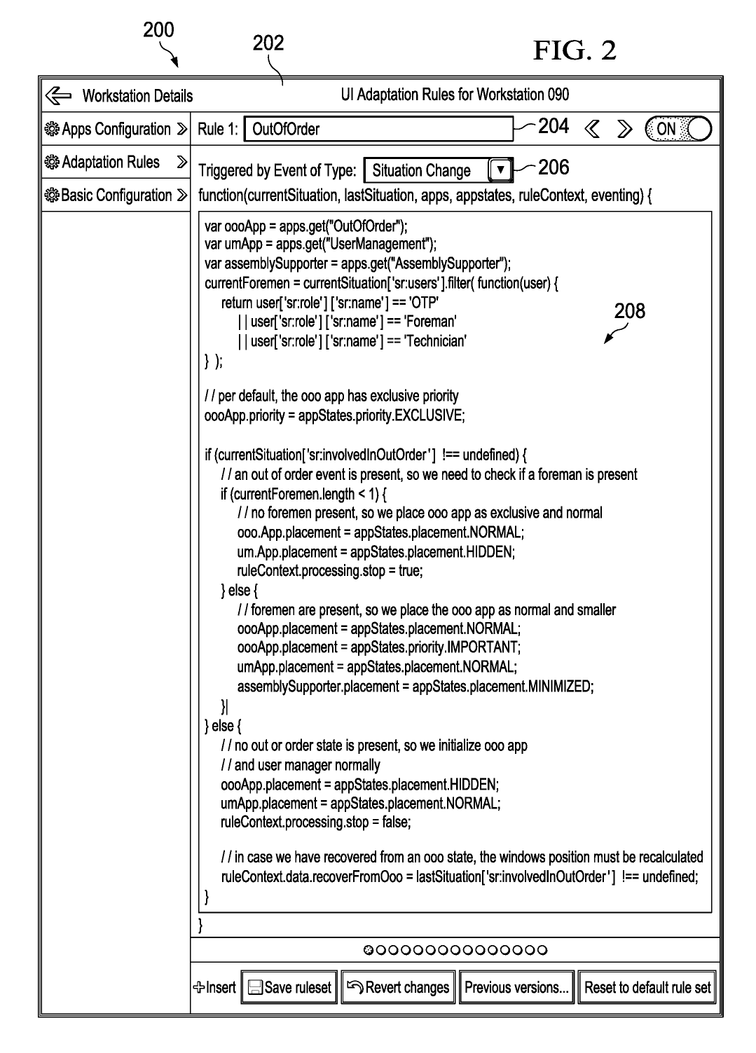

Now turning to FIG. 2, FIG. 2 illustrates an example rule editor 200 for specifying an adaptation rule, according to an implementation. The rule editor 200 can be implemented in a browser window 202. A user (e.g., a system administrator or other user) can specify a rule name 204, a rule trigger 206, and a corresponding rule function 208. The rule function 208 includes parameters such as currentSituation, lastSituation, and appStates indicating the window states that can be modified by the adaptation rule; based on these parameters, a rule creator can use JavaScript to derive logical conclusions (e.g. if a user has a role “Foreman” or “Technician”, then he/she can handle situations in which a machine is out-of-order) on the current situation (or situation changes from the last known situation), and use this knowledge to modify the desired logical layout of UI apps accordingly (e.g. if a monitoring system indicates that the respective machine is out-of-order, and someone who can handle the out-of-order situations is already logged in, the monitoring system will show the UI app that assists in resolving such situations).

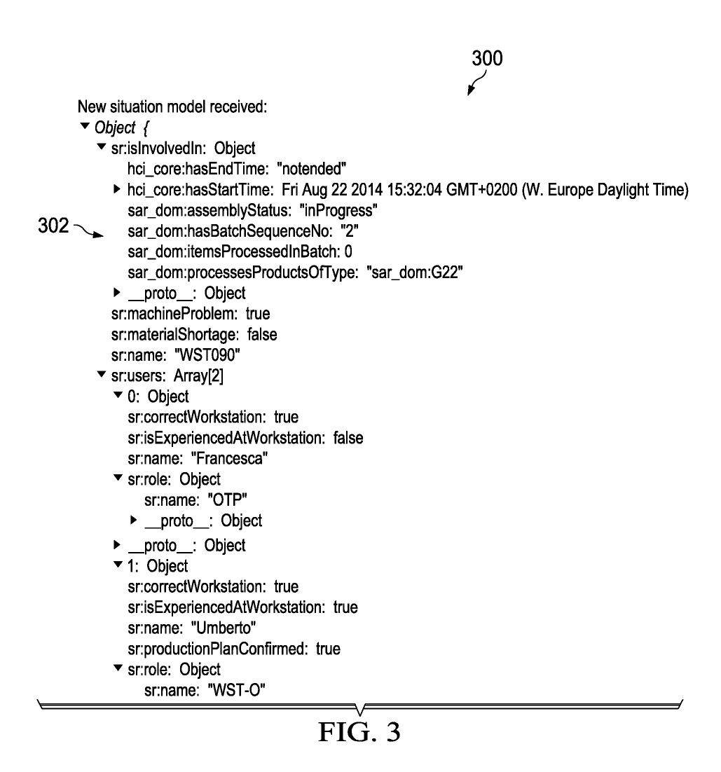

Turning to FIG. 3, FIG. 3 illustrates an example situation description 300, according to an implementation. The situation description 300 is a graph-based formal representation of a state a user is in and/or his/her environment based on machine-readable semantics (as described earlier); the implementation uses a JavaScript object notation for linked data to represent a graph of data objects 302 in the form of a tree with (optional) cross- and back-links between data objects. Among others, using a graph-format instead of a plain tree representation has the advantage that it does not require duplication when one data object is cross-referenced from multiple other data objects in the graph. The situation description 300 can also serve as the parameters currentSituation and lastSituation in the rule function 208.

Turning back to FIG. 1, the AUI application 114 can include a rule engine 120. The rule engine 120 can pull 130 adaption rules from the rule persistence service 106 and execute adaptation rules based on the situation descriptions from the user-center context engine 110 and/or the rule triggers. The rule engine 120 can load the adaptation rules at the initial startup of the AUI application 114. In some implementations, the rule engine 120 can reload or update the adaptation rules during the run time of the AUI application 114. For example, the situation description sent to the rule engine 120 can include an indicator indicating the rule engine 120 to reload the adaption rules from the rule persistent service 106.

After executing the adaptation rules, the rule engine 120 can generate a logical layout that specifies the semantic layout needs of the UI app windows. In typical implementations, the logical layout includes the window states of the UI app windows that have been manipulated by the adaptation rules based on the user's current context. In some implementations, the initial window states of UI apps can be specified in an editor (e.g., a browser-based editor, by a system administer or a user) and the adaptation rules can manipulate the initial window states based on the user's context information.

The following example illustrates a possible logical layout (i.e., the window states) of two UI app windows: UserManagement and ProductionPlanStatus:

this.windowStates = [

{ window : “UserManagement”,

area : this.area.INFO,
priority : this.priority.EXCLUSIVE,
placement : this.placement.NORMAL,
inputRequired : false,
preferredSize : { width : 2, height : 1 },
maxSize : { maxWidth : −1, maxHeight : −1 }

}, ...
{ window : “ProductionPlanStatus”,

area : this.area.APP,
priority : this.priority.DEFAULT,
placement : this.placement.NORMAL,
inputRequired : false,
preferredSize : { width : 3, height : 3 },
maxSize : { maxWidth : 3, maxHeight : −1 }

}, ...

]

In the above example, the semantic layout needs for the UserManagement UI app window include:
displaying the UserManagement UI app window in the INFO semantic area (semantic area will be discussed below),
an exclusive window priority, i.e., displaying the UserManagement UI app window on top and suppressing other UI app windows,
a preferred window size of two tiles in width and one tile in height.
a maximum window size of no constrain (the special value of −1 indicates that the maximum size is not constrained), and
a window placement of normal.

The layout manager 122 can take the logical layout from the rule engine 120 and determine a physical layout (i.e., a concrete screen layout) that tries to fulfill all semantic layout needs expressed by the logical layout. Once the physical layout is calculated, the layout manager 122 can initiate displaying the UI app windows accordingly with smooth transitions. For example, UI app windows can be transitioned to their new positions by smooth animation. Newly hidden UI app windows can be smoothly faded out and newly displayed UI app windows can be smoothly faded in.

The layout manager 122 can divide the AUI application window (e.g., the browser window displaying the AUI) into tiles. A tile is a basic unit to display a UI app window. For example, a tile can be defined as 240 pixels wide and 325 pixels high. For a full, high-definition (HD) display, the most common resolution in today's display devices, the screen can include a grid of 8×3 tiles (i.e., 8 tiles in width and 3 tiles in height). If the AUI application window is resized, tiles can be added or removed. The layout manager 122 maps the UI app windows to tiles. The tile can be predefined or defined by a system administrator or a user using a browser-based editor or other editors. The tile editor can be used to specify a height and a width of a tile.

The layout manager 122 can divide the AUI application window into semantic areas. The semantic areas constitute the top level of the layout hierarchy. For example, there could be three semantic areas: 1) a WARNING area for warning messages; 2) an APP area for main UI app content; and 3) an INFO area for additional information. The WARNING area can have the highest priority (e.g., priority 0), the APP area the second highest priority (e.g., priority 1), and the INFO area the lowest priority (e.g., priority 2). The purpose of the priorities is to allow graceful degradation: should the AUI be displayed on a device with a lower resolution, the lower priority semantic areas would be reduced in size to make space for higher-priority semantic areas. In some implementations, the most left (i.e., west) column of tiles can form the INFO area, the most right (i.e., east) column of tiles form the WARNING area, and the remaining center tiles form the APP area. The following code shows an possible example configuration of semantic areas.

this.screenAreas = [

{

semanticPurpose : this.area.INFO,
anchor : this.area Anchors.WEST,
priority : 2

},
{

semanticPurpose : this.area.APP,
anchor : this.area Anchors.CENTER,
priority : 1

},
{

semanticPurpose : this.area.WARNING,
anchor : this.areaAnchors.EAST,
priority : 0

},

].

In some implementations, the semantic areas can be defined by a system administrator or a user using a browser-based editor or other type of editor. This semantic area editor can be used to specify the location and the semantic purpose of each semantic area. UI app windows are assigned to a semantic area based on the semantic purpose of the corresponding UI app.

The layout manager 122 can use a layout algorithm to determine the physical layout based on the window states and the semantic area definitions. In cases where there is not enough screen real estate in order to fulfill the semantic layout needs of the UI app windows specified in the logical layout, the algorithm tries to gracefully degrade the display by shrinking or completely hiding the UI app windows from lowest to highest priority. For example, if the window states of the UI app windows request more space than available, the UI app windows are first reduce in size and if this is not enough, the UI app windows are then hidden, starting with the lowest-priority ones. In some implementation, the layout manager 122 can use a column-based, top-to-bottom, wrap-around layout algorithm. The general strategy of the layout algorithm is to go through the tile columns and try to find areas with an appropriate width to place the next lesser important UI app window (starting from the most important one), leading to an efficient use of tiles.

Following is one example of pseudo code for the layout algorithm:

100 if there are apps with exclusive priority

110 hide all other apps

120 place the exclusive apps centered on top of each other

130 stop the layout calculation

140

150 sort apps 2-dimensional

160 1st dimension: app priority (highest to lowest)

170 2nd dimension: app's semantic area priority (highest to lowest)

180 (i.e. first group by app priority and then sort the groups internally by app's semantic area priorities)

190

200 set windownHeight as height of HTML document in browser in virtual tiles

210 set windownWidth as width of HTML document in browser in virtual tiles

220

230 start with initial area layout

240 for area WEST set top-left corner to (1,1) and size to (1,windowHeight)

250 for area EAST set top-left corner to (windowHeight-1,1) and size to (1,windowHeight)

260 for area CENTER set top-left corner to (2,1) and size to (windowWidth-2, windowHeight)

270

280 set remaining columns to window width

290 for each area

300 if remaining columns <1

310 stop the layout calculation

320 for each app in area sorted by priority

330 calculate window size in tiles

340 if placement is “minimized” use 1×1 size

350 if placement is “normal” or “maximized” use preferred size

360 if preferred width or height >screen size, shrink to screen size

370 for each tile column in the area

380 for each tile row in the area

390 if app can be placed at current column/width coordinate without collisions

400 just place it there

410 calculate how wide the area needs to be to host the placed windows

420 set remaining columns to its current value minus the needed area width.

The above pseudo code demonstrates how the layout manager determines the physical layout. For example, lines 100 to 130 handle the case if there are UI app windows with exclusive priority. In such a case, the layout manager will place the exclusive UI app windows on the top, hide all other UI app windows, and stop the layout calculation. Lines 150 to 180 sorts the UI app windows based on the window priorities and the semantic areas. Lines 200 to 260 configure the semantic areas. Lines 280 to 420 determine the physical layout based on the sorted UI app windows.

Turning now to FIG. 4, FIG. 4 illustrates an example AUI 400 with visualization of tiles, according to an implementation. The AUI 400 can be displayed in a web browser application window 402. In some implementations, the AUI 400 can make the grid visible in order to allow visualization of the described tiles. The web browser application window 402 contains tiles 404. There are 8×3 tiles in the web browser application window 402, with 8 tiles in width and 3 tiles in height. The most left column of tiles can form an INFO area, the most right column of tiles form a WARNING area, and the remaining tiles form an APP area. For example, in the product line scenario, three UI app windows are displayed in the web browser application window 402: User Management UI app window 406, Production Plan UI app window 408, and Assembly Supporter UI app window 410. The User Management UI app window 406 shows the information of the two workers that are concurrently logged in the workstation; the Production Plan UI app window 408 shows the information of the production plan; and the Assembly Supporter UI app window 410 shows the assembly instructions of the product that the workers are currently working on. Since the workers are currently assembling products, the assembly instructions are the most relevant and important information to the workers. Therefore, the Assembly Supporter UI app window 410 is displayed in the APP area and takes 4×3 tiles to occupy a large portion of the web browser application window 402, while the User Management UI app window 406 and the Production Plan UI app window 408 are minimized in the INFO area.

As illustrated in FIG. 4, in some implementations, the UI adaptation system 100 can support multiple users to be logged in the AUI application 114 concurrently. In such a case, the UI app windows can be global or per user. For a global UI app window, only one instance of the UI app is shown regardless of how many users are logged in the AUI application 114. For a per user UI app window, a separate, personalized instance of the UI app is shown for each logged in users (e.g. an individual daily task list for each user).

Turning back to FIG. 1, the AUI application 114 can include an eventing client 116. At the start up the AUI application 114, the eventing client 116 can establish a connection to the user-centered context engine 110 and subscribe to the data feeds 112 relevant to the AUI application 114.

In some implementation, the eventing client 116 can convert the situation updates received from the data feed 112 into a format that can be consumed easily by the AUI application 114. For example, the eventing client 116 can convert a flat list of facts (resource description framework (RDF) triples) into a tree of JavaScript (JS) objects, establishing property links as JavaScript object references, therefore making it easy to programmatically traverse the graph. Hence, any attributes modelled in the RDF model can be accessed directly as JS properties. For example, RDF can be used to represent the current situation and context in the user-centered context engine 110. JSON-LD (JSON linked data), an open and widely used standard for serializing RDF data, can be used as the application-level communication protocol between the user-centered context engine 110 and the AUI application 114. The eventing client 116 receives the situation updates in JSON-LD and generically (i.e. no use case specific code needs to be written) turns the situation updates into JavaScript objects that can be consumed more easily by the client JS code than JSON-LD structure. This conversion operation can be referred to objectify the data in the JSON-LD. The reason for this generic way of deserialization is that the JSON-LD contains a list of triples. For example: the situation update in JSON-LD could contain three facts: “resource x is a workStation”, “resource y is a user”, and “x has a relation called loggedInUser to y”. If these three facts are delivered as separate facts, the client code would have to look them up separately. Instead, the following example new JS object can be constructed that contains the relations as native JavaScript references:

[{

‘id’ : ‘x’,
‘type’ : ‘workStation’,

‘loggedInUser’ : {

‘id’ : ‘y’,
‘type’ : ‘user’

}

}].

Converting the situation updates from JSON-LD to JS object is a relatively simple way to keep the small context graph subset cached in the context cache 118 consistent with the complete graph in the back-end user-centered context engine 110.

The eventing client 116 can also has a local part that acts as a message bus within the AUI application 114. This allows the UI apps that reside in the AUI application 114 to use publish/subscribe methods to send and receive events among each other or from/to the AUI application 114. In this way, the UI apps also can react to context updates. For example, in the product line scenario, when a user logs in at a work station on the product line by swiping his RFID card, this event is both consumed by the rule engine 120 (where a rule changes the screen layout) as well as the user list UI app (that changes the contents from the initial message “swipe card to log in” to the user tile carousel). Further, the production status UI app can access the user profile sent with the event and, depending if the user has confirmed the daily production plan, display the respective button or hide it.

In a typical implementation, when a new scenario is deployed (e.g., a new scenario of hospital use of AUI instead of the product line scenario), content or codes of the following three components in the UI adaption system 100 can be created or updated: the inserted rules 136, the data feeds 112, and the adaptation rules 108. The remaining components in the UI adaption system 100 can be provided as framework services and the content or codes can be reused for any scenario. For example, when new data from sensors or third party systems flow into the user-centered context engine 110, the inserted rules 136 including rules that filter and relate incoming events can be updated or newly created. To identify and expose relevant situation updates to adapt the user interface at the client, the data feeds 112 can also be updated or newly created. Further, the adaptation rules 108 can be created or modified to implement the desired reactions to the situation updates pushed from the context engine. The UI apps can be re-used over different scenarios or can be adapted with reduced effort. As the functionality of the GUI is divided into small UI apps (one UI app for one purpose), reuse is greatly fostered.

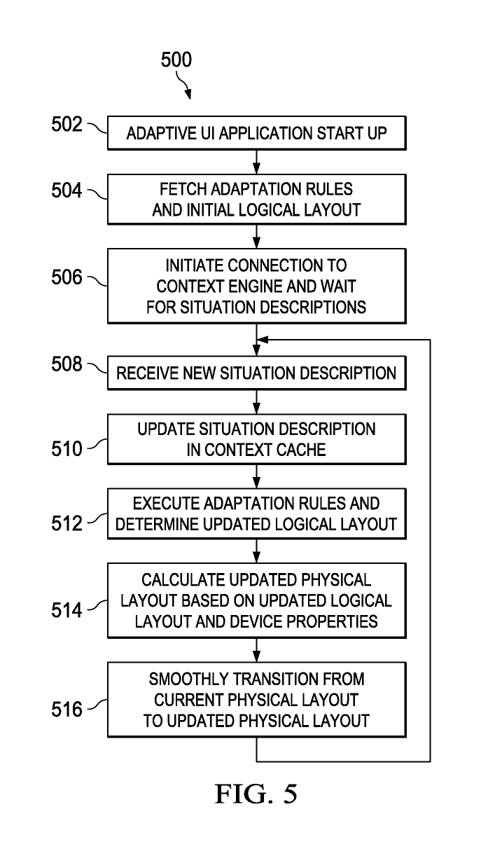

FIG. 5 is a flow chart of an example method 500 for context-driven, proactive UI adaptation, according to an implementation. For clarity of presentation, the description that follows generally describes method 500 in the context of FIGS. 1-4 and 6-10. However, it will be understood that method 500 can be performed, for example, by any suitable system, environment, software, and hardware, or a combination of systems, environments, software, and hardware as appropriate. In some implementations, various steps of method 500 can be run in parallel, in combination, in loops, and/or in any order.

At 502, the AUI application starts up. In a typical implementation, the AUI application can be started by opening the corresponding application URL in a browser. In some implementation, if the client does not have the AUI application, the client can first fetch or download the AUI application from the server. The AUI application can be implemented in HTML, JavaScript, Cascading Style Sheets (CSS), or other computing languages. From 502, method 500 proceeds to 504.

At 504, the AUI application fetches the adaptation rules and the initial logical layout. The rule engine can load the adaptation rules from the rule persistence service at the server. The rule engine can pull the adaptation rules from the rule persistence service by sending a request and getting the respective rule set in response to the request. The rule persistence service can also push the adaptation rules to the rule engine. The rule engine can fetch the initial logical layout from the server. The initial logical layout can include the initial window states of the UI app windows. In some implementations, the rule engine may not fetch the initial logical layout if the initial logical layout is stored in the AUI application. From 504, method 500 proceeds to 506.

At 506, the AUI application initiates a connection to the context engine and waits for new situation descriptions. The situation description can be derived from sensor data or information from a third party system that provides the user's context information. The eventing client can establish a persistent connection to the context engine and subscribe to relevant data feeds on the context engine. The context engine can assign the instantiated data feeds to the respective connection. If the evaluation detects new information that is relevant for the AUI application, the new situation description is sent to the eventing client through one or more connections to the connected eventing client. The context engine can push the new situation description to the eventing client or the eventing client can send a request to the context engine for pulling the new situation description. Depending on the networking environment (e.g. network proxy may prevent Web Socket connectivity), the push operation can be implemented either via WebSockets or via a periodic or long polling approach. From 506, method 500 proceeds to 508.

At 508, the eventing client in the AUI application receives the new situation description from the context engine and passes to the context cache. From 508, method 500 proceeds to 510.

At 510, the context cache in the AUI application updates the content with the new situation description. For example, the received new situation description can be stored in the context cache. In a typical implementation, the context information in the context store is represented by a graph of data objects, and the situation description received at the context cache can be a subset of the graph (i.e., a sub-graph) in the context store relevant to the current user context. For example, the context store can store a complete graph describing all situations relevant to the scenario, and the context cache can store a sub-graph describing the user's current situation. From 510, method 500 proceeds to 512.

At 512, the rule engine in the AUI application identifies adaption rules based on the received situation description and executes the identified adaption rules. By executing the identified adaption rules, the rule engine determines an updated logical layout. In some implementations, each adaptation rule in the rule engine can inspect the updated situation description in the context cache and, if necessary, manipulate the window states for the UI apps. The window states represent the logical layout which specifies the semantic layout needs of the UI apps. For example, the semantic layout needs can include in which semantic area a UI app window should be placed, with which priority (less important windows will be reduced in size or hidden if there is not enough space on the screen), what is the preferred window size, etc. The semantic layout needs of the UI app windows can be stored in a data structure in the AUI application. From 512, method 500 proceeds to 514.

At 514, the layout manager in the AUI application calculates an updated physical layout based on the updated logical layout and device properties. The layout manager can determine the physical layout (i.e., the actual screen layout) such as the window positions and window sizes in pixels. The device properties can include the screen size of the device (e.g., a mobile phone or a desktop). The layout manager can use a layout algorithm to calculate a physical layout, trying to address the semantic layout needs of the UI app windows. The layout algorithm takes into account the screen size available for the AUI and tries to fit the UI app windows. A same logical layout can be reused across different devices and maps to different physical layout based on the devices' properties. For example, the most relevant UI app windows could be shown on a small screen size of a mobile device, while on the desktop additional UI app windows would be displayed. From 514, method 500 proceeds to 516.

At 516, the AUI application can initiate the UI display based on the determined updated physical layout. The AUI application can smoothly transition from the current physical layout to the updated physical layout. For example, newly hidden UI app windows can be smoothly faded out and newly displayed UI app windows can be smoothly faded in. After 516, method 500 proceeds back to 508 to wait for newly arrived situation descriptions.

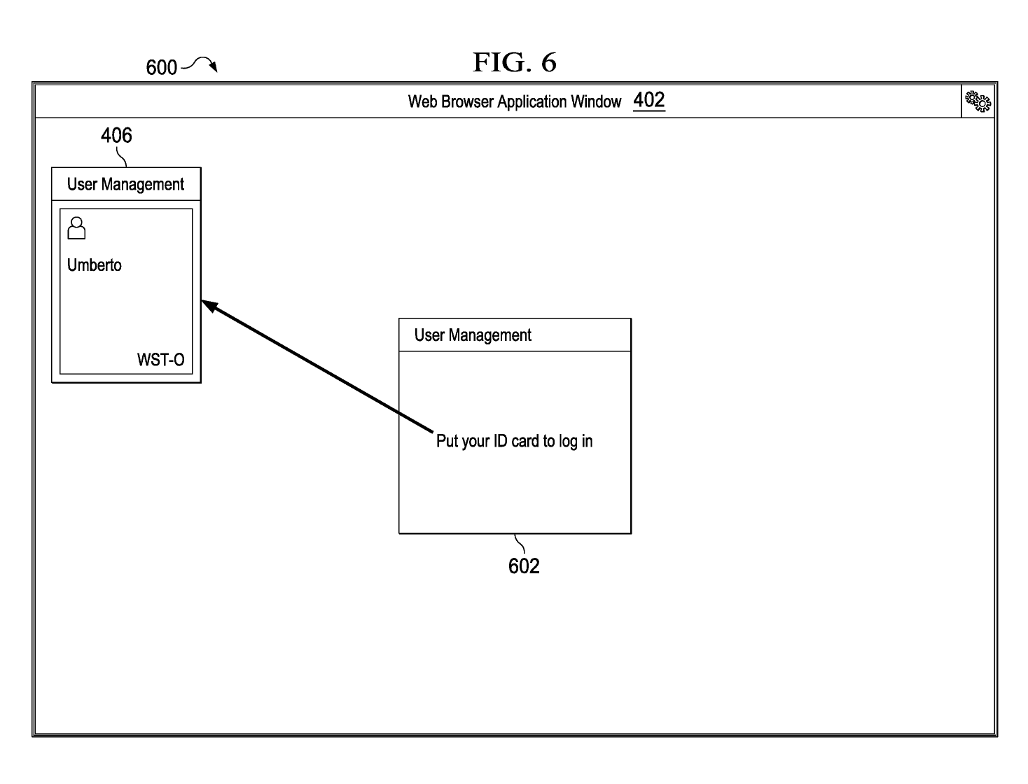

FIGS. 6-9 illustrate examples of how the AUI adapts to the user context in a production line scenario, according to an implementation. Note that the illustrated AUIs in FIGS. 6-9 do not have the above described grid enabled and hence the tiles are not visible. As will be understood by those of ordinary skill in the art, the following example GUI functionality is only one possible implementation possible. Other implementations consistent with this disclosure are considered to be within the scope of this disclosure.

FIG. 6 illustrates a first example of an AUI 600, according to an implementation. The AUI 600 is displayed in a web browser window 402. When no user is logged in at the work station, all UI app windows are hidden except for a User Management UI app window 602 that asks for authentication. When the first user logs in (e.g. by putting his ID card on a reader device or simply by entering a predefined geographical area), the User Management UI app window 602 is made smaller, changes content, and moved to top left as an minimized User Management UI app window 406.

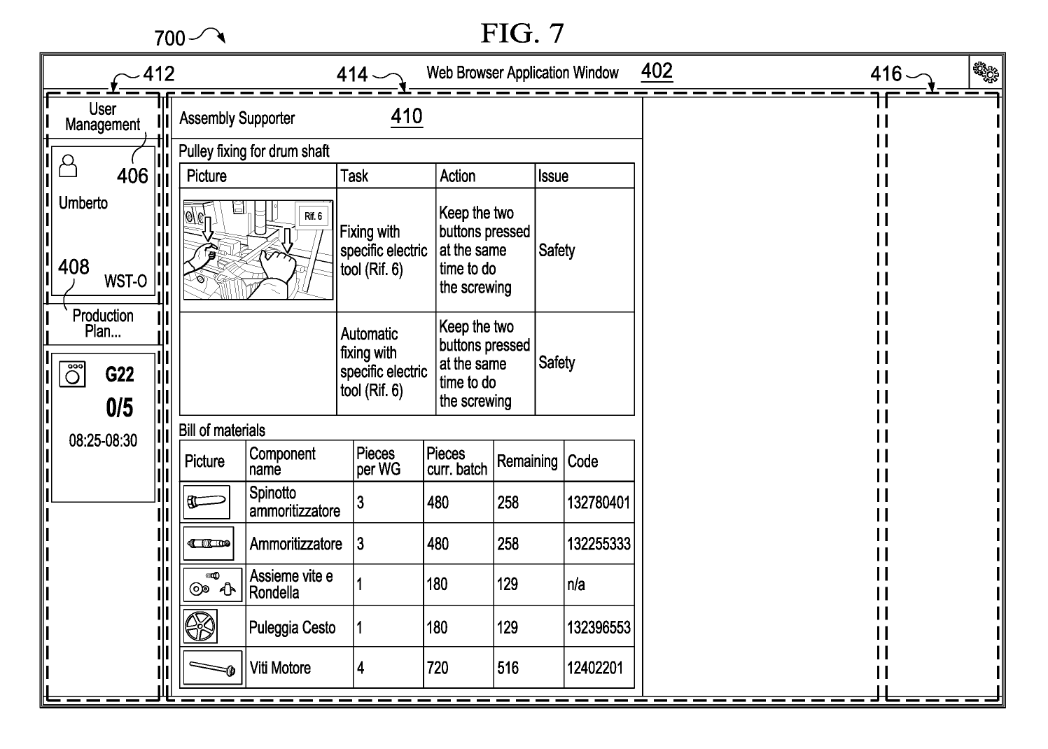

FIG. 7 illustrates a second example of an AUI 700, according to an implementation. The AUI 700 is displayed in the web browser application window 402. Now from sensor data collected from the product line, the UI adaptation system determines that the newly logged-in user is in regular operation situation and is supposed to start assembling washing machines. In this situation, the newly logged-in user needs to know which parts to use and how many machines to assemble. The AUI adapts in such a way that the information needed by the user in this situation is displayed. For example, two new UI app windows can appear: 1) Production Plan UI app window 408 for production status information and 2) Assembly Supporter UI app window 410 for assembly instructions. Since the assembly instructions are the most important and relevant information to the user at this moment, the Assembly Support UI app window 410 is displayed in the APP area 414 taking a large portion the web browser application window 402, while the User Management UI app window 406 and the Production Plan UI app window 408 are minimized in INFO area 412. Note that since there is no warning messages at this time, there is no UI app window in the WARNING area 416.

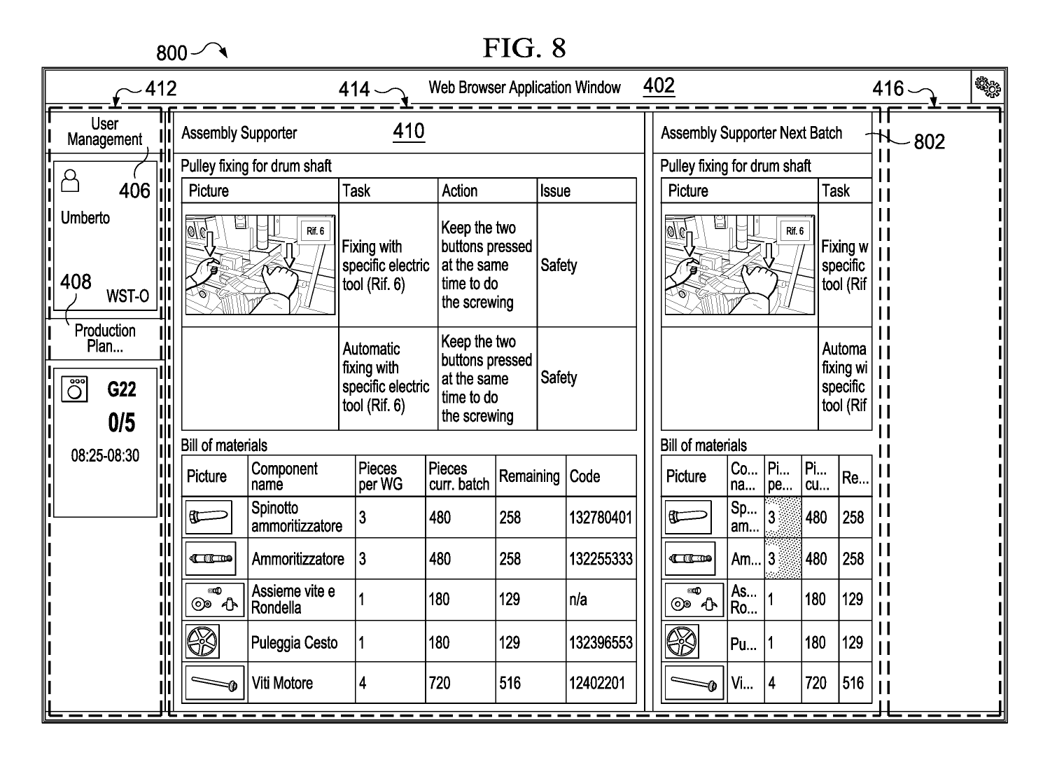

FIG. 8 illustrates a third example of an AUI 800, according to an implementation. The AUI 800 is displayed in the web browser application window 402. From sensor data collected from the product line, the UI adaptation system determines that a new batch of products is about to approach. Accordingly, the user's situation changes from regular operation to batch operation because the user is required to perform different assembly steps for the product model of the new batch. Therefore, a new window, Assembly supporter Next Batch UI app window 802, appears in the APP area 414, highlighting the changes in assembly steps. Since the user has not started the new batch yet, the information in Assembly Support UI app window 410 is considered to be more important and relevant to the user that the information in the Assembly supporter Next Batch UI app window 802. Thus, the Assembly Support UI app window 410 takes more space than the Assembly supporter Next Batch UI app window 802 in the APP area 414. Meanwhile, the User Management UI app window 406 and the Production Plan UI app window 408 are minimized in INFO area 412, and no UI app window in the WARNING area 416.

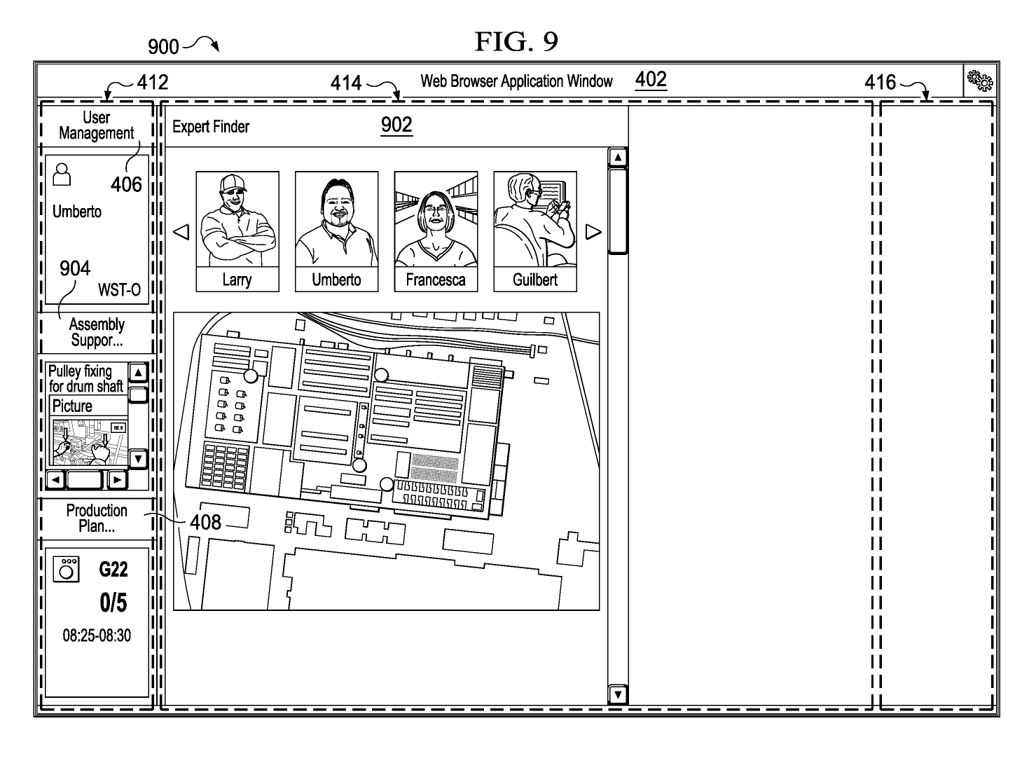

FIG. 9 illustrates a fourth example of an AUI 900, according to an implementation. AUI 900 is displayed in the web browser application window 402. Here, sensors on the product line detect an exceptional situation (e.g., machine breakdown) which requires assistance of an expert. Thus, all other information considered irrelevant/unimportant to this particular situation is removed. As illustrated, the Assembly supporter Next Batch UI app window 802 disappears; the Assembly Support UI app window 904 is minimized and moved to the left in the INFO area 412; and a new Expert Finder UI app window 902 pops up in the APP area 414. The User Management UI app window 406 and the Production Plan UI app window 408 remain in the INFO area 412. Again no UI app window is in the WARNING area 416.

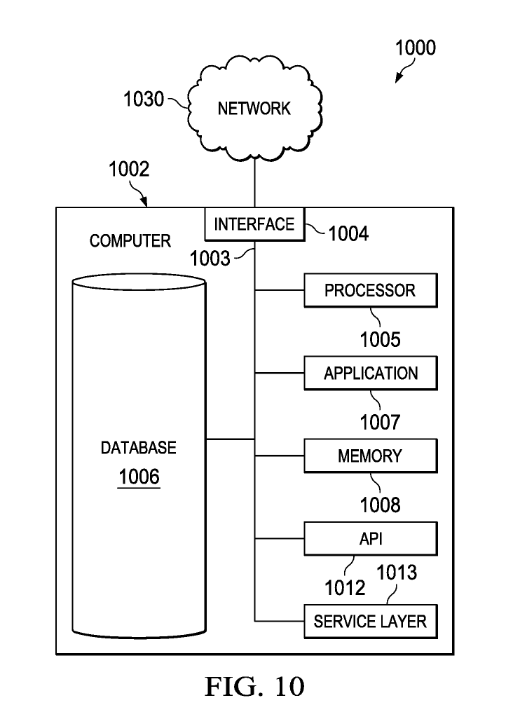

FIG. 10 is a block diagram of an exemplary computer used for implementing the described subject matter, according to an implementation. The illustrated computer 1002 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 1002 may comprise of a computer that includes an input device, such as a keypad, keyboard, touch screen, or other device that can accept user information, and an output device that conveys information associated with the operation of the computer 1002, including digital data, visual and/or audio information, or a GUI.

The computer 1002 can process for/serve as a client (e.g., client 104 or one or more subcomponents), a server (e.g., server 102 or one or more subcomponents), and/or any other component of the described exemplary hardware/software architecture (whether or not illustrated). The illustrated computer 1002 is communicably coupled with a network 1030.

At a high level, the computer 1002 is an electronic computing device operable to receive, transmit, process, store, or manage data and information. According to some implementations, one or more components of the computer 1002 may be configured to operate within a cloud-computing-based environment and the computer 1002 may also include or be communicably coupled with a cloud-computing server, application server, e-mail server, web server, caching server, streaming data server, business intelligence (BI) server, and/or other server.

The computer 1002 can generate requests to transmit over network 1030 (e.g., as a client 104) or receive requests (e.g., as a server 102) over network 1030 from a client application (e.g., a web browser or other application) and responding to the received requests by processing the said requests in an appropriate software application, hardware, etc. In addition, requests may also be sent to the computer 1002 from internal users (e.g., from a command console or by other appropriate access method), external or third-parties, other automated applications, as well as any other appropriate entities, individuals, systems, or computers.

Each of the components of the computer 1002 can communicate using a system bus 1003. In some implementations, any and/or all the components of the computer 1002, both hardware and/or software, may interface with each other and/or the interface 1004 over the system bus 1003 using an API 1012 and/or a service layer 1013. The API 1012 may include specifications for routines, data structures, and object classes. The API 1012 may be either computer-language independent or dependent and refer to a complete interface, a single function, or even a set of APIs. The service layer 1013 provides software services to the computer 1002 and/or the described exemplary hardware/software architecture. The functionality of the computer 1002 may be accessible for all service consumers using this service layer. Software services, such as those provided by the service layer 1013, provide reusable, defined business functionalities through a defined interface. For example, the interface may be software written in JAVA, C++, or other suitable language providing data in extensible markup language (XML) format or other suitable format. While illustrated as an integrated component of the computer 1002, alternative implementations may illustrate the API 1012 and/or the service layer 1013 as stand-alone components in relation to other components of the computer 1002 and/or the described exemplary hardware/software architecture. Moreover, any or all parts of the API 1012 and/or the service layer 1013 may be implemented as child or sub-modules of another software module, enterprise application, or hardware module without departing from the scope of this disclosure.

The computer 1002 includes an interface 1004. Although illustrated as a single interface 1004 in FIG. 10, two or more interfaces 1004 may be used according to particular needs, desires, or particular implementations of the computer 1002 and/or the described exemplary hardware/software architecture. The interface 1004 is used by the computer 1002 for communicating with other systems in a distributed environment—including within the described exemplary hardware/software architecture—connected to the network 1030 (whether illustrated or not). Generally, the interface 1004 comprises logic encoded in software and/or hardware in a suitable combination and operable to communicate with the network 1030. More specifically, the interface 1004 may comprise software supporting one or more communication protocols associated with communications such that the network 1030 or interface's hardware is operable to communicate physical signals within and outside of the illustrated exemplary hardware/software architecture.

The computer 1002 includes a processor 1005. Although illustrated as a single processor 1005 in FIG. 10, two or more processors may be used according to particular needs, desires, or particular implementations of the computer 1002 and/or the described exemplary hardware/software architecture. Generally, the processor 1005 executes instructions and manipulates data to perform the operations of the computer 1002. Specifically, the processor 1005 executes the functionality required for context-driven, proactive adaptation of UI.

The computer 1002 also includes a database 1006 and memory 1008 that hold data for the computer 1002 and/or other components of the described exemplary hardware/software architecture. Although illustrated as a single database 1006 and memory 1008 in FIG. 10, two or more databases 1008 and memories 1008 may be used according to particular needs, desires, or particular implementations of the computer 1002 and/or the described exemplary hardware/software architecture. While database 1006 and memory 1008 are illustrated as integral components of the computer 1002, in alternative implementations, the database 1006 and memory 1008 can be external to the computer 1002 and/or the described exemplary hardware/software architecture. In some implementations, the database can be a conventional database or an in-memory database, or a mix of both. In some implementations, the database 1006 and memory 1008 can be combined into one component.

The application 1007 is an algorithmic software engine providing functionality according to particular needs, desires, or particular implementations of the computer 1002 and/or the described exemplary hardware/software architecture, particularly with respect to functionalities required for context-driven, proactive adaptation of UI. For example, application 1007 can serve as a server 102, rule persistence service 106, adaptation rules 108, user-centered context engine 110, data feeds 112, context store 132, instance pump 134, inserted rules 136, client 104, AUI application 114, eventing client 116, context cache 118, rule engine 120, layout manger 122 (as either executing on the client or server), and/or any other component of the described exemplary hardware/software architecture (whether or not illustrated). Further, although illustrated as a single application 1007, the application 1007 may be implemented as multiple applications 1007 on the computer 1002. In addition, although illustrated as integral to the computer 1002, in alternative implementations, the application 1007 can be external to the computer 1002 and/or the described exemplary hardware/software architecture.

There may be any number of computers 1002 associated with, or external to, the described exemplary hardware/software architecture and communicating over network 1030. Further, the term “client,” “user,” and other appropriate terminology may be used interchangeably as appropriate without departing from the scope of this disclosure. Moreover, this disclosure contemplates that many users may use one computer 1002, or that one user may use multiple computers 1002.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatuses, devices, and machines for processing data, including by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking and/or parallel processing may be advantageous and performed as deemed appropriate.

Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
receiving a situation description from a context engine, the situation description describing a context of a user, wherein the user is associated with a graphical user interface, and the graphical user interface is associated with a screen area;
identifying a user interface adaption rule based on the received situation description;
determining a logical layout based on the identified user interface adaptation rule;
determining a physical layout based on the logical layout; and
initiating display of the graphical user interface on the screen area based on the determined physical layout.

2. The method of claim 1, wherein the situation description is derived from sensor data or information from a third party system that provides context information of the user.

3. The method of claim 1, wherein the situation description is a graph of data objects.

4. The method of claim 1, further comprising:
fetching adaptation rules and initial logical layout; and
initiating a connection to the context engine.

5. The method of claim 1, wherein determining a logical layout based on the identified user interface adaptation rule comprises determining semantic layout information of at least one user interface app window based on the identified user interface adaptation rule.

6. The method of claim 5, wherein the semantic layout information includes at least one of a semantic area, a window priority, or a preferred window size for the at least one user interface app window.

7. The method of claim 5, wherein determining the physical layout based on the logical layout comprises determining a window size and a window position of the at least one user interface application window based on the semantic layout information in the logical layout and properties of the screen area.

8. A non-transitory, computer-readable medium storing computer-readable instructions, the instructions executable by a computer and configured to:
receive a situation description from a context engine, the situation description describing a context of a user, wherein the user is associated with a graphical user interface, and the graphical user interface is associated with a screen area;
identify a user interface adaption rule based on the received situation description;
determine a logical layout based on the identified user interface adaptation rule;
determine a physical layout based on the logical layout; and
initiate display of the graphical user interface on the screen area based on the determined physical layout.

9. The non-transitory, computer-readable medium of claim 8, wherein the situation description is derived from sensor data or information from a third party system that provides context information of the user.

10. The non-transitory, computer-readable medium of claim 8, wherein the situation description is a graph of data objects.

11. The non-transitory, computer-readable medium of claim 8, comprising one or more instructions to:
fetch adaptation rules and initial logical layout; and
initiate a connection to the context engine.

12. The non-transitory, computer-readable medium of claim 8, wherein determining a logical layout based on the identified user interface adaptation rule comprises determining semantic layout information of at least one user interface app window based on the identified user interface adaptation rule.

13. The non-transitory, computer-readable medium of claim 12, wherein the semantic layout information includes at least one of a semantic area, a window priority, or a preferred window size for the at least one user interface app window.

14. The non-transitory, computer-readable medium of claim 12, wherein determining the physical layout based on the logical layout comprises determining a window size and a window position of the at least one user interface application window based on the semantic layout information in the logical layout and properties of the screen area.

15. A system, comprising:
a computer memory;
a hardware processor interoperably coupled with the computer memory and configured to:
receive a situation description from a context engine, the situation description describing a context of a user, wherein the user is associated with a graphical user interface, and the graphical user interface is associated with a screen area;
identify a user interface adaption rule based on the received situation description;
determine a logical layout based on the identified user interface adaptation rule;
determine a physical layout based on the logical layout; and
initiate display of the graphical user interface on the screen area based on the determined physical layout.

16. The system of claim 15, wherein the situation description is derived from sensor data or information from a third party system that provides context information of the user.

17. The system of claim 15, wherein the situation description is a graph of data objects.

18. The system of claim 15, configured to:
fetch adaptation rules and initial logical layout; and
initiate a connection to the context engine.

19. The system of claim 15, wherein determining a logical layout based on the identified user interface adaptation rule comprises determining semantic layout information of at least one user interface app window based on the identified user interface adaptation rule.

20. The system of claim 19, wherein determining the physical layout based on the logical layout comprises determining a window size and a window position of the at least one user interface application window based on the semantic layout information in the logical layout and properties of the screen area.
